(19) United States
(12) Patent Application Publication
(10) Pub. No.: US 2025/0180928 A1
(43) Pub. Date: Jun. 5, 2025

(54) FILTERS TO ENHANCE COLOR VISION

(71) Applicant: ENCHROMA, INC., Berkeley, CA (US)

(72) Inventors: Donald M. McPherson, Oakland, CA (US); Roger William Ellicock, JR., Berkeley, CA (US); Sunil K. Koovakkat, Hercules, CA (US)

(73) Assignee: ENCHROMA, INC., Berkeley, CA (US)

(21) Appl. No.: 18/957,096

(22) Filed: Nov. 22, 2024

Related U.S. Application Data
(60) Provisional application No. 63/604,465, filed on Nov. 30, 2023.

(51) Int. Cl. G02C 7/10; G02C 7/12

(52) U.S. Cl. CPC G02C 7/104; G02C 7/12

(57) ABSTRACT

This application discloses an optical filter designed to enhance color contrast even for people with ostensibly normal color vision. The optical filter design relies on optimizing a set of parameters that correlate to improved or enhanced color perception. In particular, the parameter Sigma(θ) is optimized.

### CROSS REFERENCE TO RELATED APPLICATIONS

This application claims benefit of priority to U.S. Provisional Patent Application No. 63/604,465, which is incorporated herein by reference in its entirety.

### FIELD OF THE INVENTION

The invention relates generally to optical filters to enhance color vision.

### BACKGROUND

Optical filters are devices having wavelength-selective transmission acting on sources or receivers of lights. Such filters may be configured to transform aspects of color appearance as seen by the human eye. Optical filters that improve or modify aspects of color vision may provide benefit to persons with color vision deficiency (CVD) and to persons with normal color vision (NCV). Some relevant prior research and work into color vision, color vision disorders, and vision research are listed below.
[MacLeod & Boynton, 1979] MacLeod, D. I. A. & Boynton, R. M. (1979). Chromaticity diagram showing cone excitation by stimuli of equal luminance. Journal of the Optical Society of America, 69(8), 1183-1186.
[Moreland, et al., 2010] Moreland J D, Westland S, Cheung V, Dain S J. (2010) Quantitative assessment of commercial filter ‘aids’ for red-green colour defectives. Ophthalmic Physiol Opt. September; 30(5):685-92.
[CIE, 2004] CIE TC 8-01 (2004). A Color appearance model for color management systems. Publication 159. Vienna: CIE Central Bureau. ISBN 3-901906-29-0.
[Winkler, et al., 2015] Winkler, A. D., Spillmann, L., Werner, J. S. & Webster, M. A., (Jun. 29, 2015) Asymmetries in blue-yellow color perception and in the color of ‘the dress’, Current Biology. Volume 25, Issue 13, PR547-R548.
[Munsell, 1976] Munsell Book of Color—Glossy Finish Collection, Munsell Color, Baltimore, Md., 1976 (https://sites.uef.fi/spectral/databases-software/munsell-colors-glossy-all-spectrofotometer-measured/)
[IES 2020] Illuminating Engineering Society. 2020. ANSI/IES TM-30-20 Method for Evaluating Light Source Color Rendition. New York. 34p. Technical memorandum describing the TM-30 method. Reflectance spectra are shown in FIG. 1 on page 4. The data for the reflectance spectra and the CIE Illuminant D65 are available in the file “IES TM-30-18 Advanced CalculationTool v2.01.xlsm” which accompanies the memorandum when downloaded here: https://store.ies.org/product/tm-30-20-ies-method-for-evaluating-light-source-color-rendition/?v=7516fd43adaa. This technical memorandum, the data for reflective spectra, and the file “IES TM-30-18 Advanced CalculationTool v2.01.xlsm” file are incorporated herein by reference in its entirety.
[Stockman et al., 1999] Stockman, A., Sharpe, L. T., & Fach, C. C. (1999). The spectral sensitivity of the human short-wavelength cones. Vision Research, 39, 2901-2927. This journal article is incorporated herein by reference in its entirety.
[Stockman et al., 2000] Stockman, A., & Sharpe, L. T. (2000). Spectral sensitivities of the middle- and long-wavelength sensitive cones derived from measurements in observers of known genotype. Vision Research, 40, 1711-1737. This journal article is incorporated herein by reference in its entirety.
[Kaneko et al., 2020] Kaneko S, Kuriki I, Andersen S K. (2020). Steady-State Visual Evoked Potentials Elicited from Early Visual Cortex Reflect Both Perceptual Color Space and Cone-Opponent Mechanisms. Cereb Cortex Commun. September 1; 1(1):tgaa059.

### SUMMARY

This application discloses a filter designed to enhance color contrast even for people with ostensibly normal color vision. The filter designs will also benefit the NCV who are developing acquired color vision deficiency (CVD) through disease or age. The filter design relies on optimizing a set of parameters that correlate to improved or enhanced color perception. In particular, the parameter Sigma(θ) is optimized. Sigma(θ) is defined as:

$$Sigma ( θ ) = 100 * ( \frac{{σ}_{F} ( θ )}{σ ( θ )} - 1 )$$

where θ is angle of the axis of measurement relative to the horizontal, σ_{F}F(θ) is the standard deviation of chromaticity coordinates of reflectance surfaces in a color set calculated with the filter, and σ(θ) is the standard deviation of chromaticity coordinates of reflectance surfaces in a color set calculated without the filter. The preferred color and reflectance set is the color and reflectance set used in ANSI/IES TM-30-20 [IES 2020]. The ANSI/IES TM-30-20 standard and its associated color samples and reflectance set are incorporated herein by reference in its entirety.

In one embodiment, the optical filter has a transmission spectrum that gives a maximum Sigma(θ) value at θmax and a minimum Sigma(θ) value at θmin, where the maximum Sigma(θ) value is greater than 35 and θmax is between 20 to 60 degrees, and wherein the minimum Sigma(θ) value is between −10 and 10. In some embodiments, the optical filter has a transmission spectrum that gives a maximum Sigma(θ) value at θmax and a minimum Sigma(θ) value at θmin, wherein the maximum Sigma(θ) value is greater than 25, θmax is between 20 to 60 degrees, and the minimum Sigma(θ) value is between −6 and 6.

In some embodiments the filter has a chromaticity, measured under D-65 illuminant, less than 0.0200 distance from the chromaticity of the illuminant in the CIE 1931 2-deg color space, and with the correlated color temperature being greater than 4,500K and less than 7,000K, and the visible light transmission being greater than 9% and less than 18%, preferably greater than 11% and less than 16%. In some embodiments, the filter has a chromaticity, measured under D-65 illuminant, less than 0.0200 distance from the chromaticity of the illuminant in the CIE 1931 2-deg color space, and with the correlated color temperature being greater than 4,500K and less than 7,000K, and the visible light transmission being greater than 18% and less than 40%, preferably greater than 22% and less than 29% and even more preferably greater than 24% and less than 27%.

In some embodiments, the filter has a chromaticity, measured under D-65 illuminant, less than 0.0200 distance from the chromaticity of the illuminant in the CIE 1931 2-deg color space, where the filter reduces brightness equating to approx. 8-18% VLT, or 18-40% VLT for category 3 and category 2 sun lenses, resp., has a correlated color temperature between 4,500-7,000 K, has a maximum saturation greater than 1.45 (45%) and oriented between 20-40 degrees, the minimum saturation being between −1.05 and 1.05 (−5 and +5%) and oriented approx. orthogonal to the angle of maximum saturations.

In some embodiments, the filter incorporates a polarizer element. In some embodiments, the minimum Sigma(θ) value of filter is between −10 and 10 and θmin is between 80 to 120 degrees.

### BRIEF DESCRIPTION OF THE DRAWINGS

FIG. 1 shows the Sigma(θ) plot for embodiment NCV-107.

FIG. 2 shows the Sigma(θ) plot for embodiments NCV-101, NCV-102, and NCV-103.

FIG. 3 is a spectral transmission plot of polarizer HT-S50.

FIG. 4 shows the Sigma(θ) plot for embodiments P-200 (NCV-200) and P-204 (NCV-204).

FIG. 5 shows SuperX® polarized filter transmission spectrum 400-700 nm.

FIG. 6 shows the Sigma(θ) plot for the SuperX® filter, i.e. a polar plot of r_{F} (0).

### DETAILED DESCRIPTION

This invention relates to color contrast enhancing eyewear for people with ostensibly normal color vision (NCV). The filter designs will also benefit the NCV who are developing acquired color vision deficiency (CVD) through disease or age. The filter design relies on optimizing a set of parameters that correlate to improved or enhanced color perception. Specifically, the filters control color difference that can be represented as magnitude along specific directions in a cone excitation space (CES). Analysis of filter performance is made in a MacLeod-Boynton CES (MacLeod & Boynton, 1979) that is modified to scale more perceptually uniformly. The filters can also be analyzed in CMF-based color space, such as CIE 1931, CIE 1965, L*a*b*, and LCH color spaces. This allows filter properties such as VLT, delta-E, CCT, chromaticity, dominant hue, and chroma to be combined with performance values from the CES analysis to fully describe the filter.

Analysis can be made with any reflectance color set that is representative of full color space. Candidate sets will be discussed. For the purposes of this invention, we use the reflectance set used in the ANSI/IES TM-30-20 standard (the TM-30 reflectance set). [IES 2020] Performance is measured by computing the standard deviation of the set and examining the change to the L and S values in the CES. For NCV, increased color contrast is desired along the L direction in CES, and a nearly unchanged color contrast is desired along the S direction. These equate to an increased standard deviation of the set for L and a small change in the standard deviation of the set for S. Additionally, the scalar quantities L and S can be transformed into a polar equivalent of a vector r and an angle, and the performance evaluated as a function of the angle in the CES. Best-performance is found for filters that describe an ellipse with maximum standard deviation approx. along the lime-magenta color direction, corresponding to a line bisecting 45°-225° through the neutral point. The region of best performance corresponds to a major ellipse angle approx. 20-60° bisecting the neutral point through to 200-240°. The increase in r along this line should be greater than 25% relative to a circle (circular profile means the filter has no change on performance, like with a perfect neutral density filter). The corresponding minor axis should be approx. 900 rotated relative to the major axis and have a corresponding r close to unity.

The transformed set can be evaluated in either CES or CIE-type color spaces as a cone angle or hue angle, resp. Transforming CES results into CIE XYZ color space is only possible for NCV where the CMFs are well defined. The transformation to CIE XYZ allows evaluation of the filter tint (hue, saturation and lightness as seen with NCV) as a chromaticity value (e.g., [x,y]; [u′,v′]; [a*,b*]) and visible light transmission (VLT). A secondary part of the design algorithm sets chromaticity bounds to establish the lens appearance as more or less neutral in color (ΔE relative to a set of reference illuminants is small in magnitude), as well as maintaining the correlated color temperature (CCT) close in value to the design illuminant, e.g., D-65 daylight, and the set of reference illuminants, such as the D-series. These describe ‘secondary’ design criteria and are as critical as the primary design goal of increasing suprathreshold color saturation along the lime-magenta color direction while leaving color saturation virtually unchanged along the cyan-orange color direction. The rationale behind imposing the secondary set of design criteria is that color perception has evolved with the orange-cyan axes tuned to sky-earth which plays a role in determining the scene illuminant by evaluating the reflective surfaces. Maintaining a neutral filter color and the CCT close to the design illuminant keeps this relationship intact (no blue dress effect). Furthermore, the higher-order color vision mechanisms are tuned to these perceptual hue directions and in the case of orange-cyan rely on this information to determine edge location and object properties lit indirectly (blue sky) and directly (yellow sunlight). It has been found through experimental evaluation of filter designs that the filter chromaticity should be kept close to the illuminant chromaticity, which also maintains the filter CCT close to the illuminant CCT. Therefore, a filter design that follows these prescriptions should have small delta-E and small delta-CCT with respect to the D-series of illuminants; D50, D55, D60, D65, D70, D75, D80. Keeping delta-E small (below 0.0200) for each illuminant automatically keeps delta-CCT small.

### DETAILED DESCRIPTION

There are multiple methods for evaluating filter performance which involve calculating the color space coordinates of a set of reflectance surfaces both with and without the filter. In general, the goal of a color-enhancing filter is to increase the saturation of a set or subset of colors. In an isoluminant chromaticity space, the saturation of a color is related to its distance from the white point. Therefore, the effect of a filter on color saturation may be evaluated by modeling how the filter changes the distance from the white point for the reflectance surfaces in the color set.

In the Sigma method, the standard deviation of the chromaticity coordinates of the reflectance surfaces in the color set is calculated both with and without the filter. The standard deviation is used here as a convenient way to quantify the average distance from the white point and is a measure of the “spread” of the set. The color set must be evenly distributed across color space, so that the mean of the set's chromaticity coordinates is close to the coordinates of the white point. The standard deviation is calculated separately for the two orthogonal axes of the chromaticity space to measure the spread in each dimension. In other words, the standard deviation is calculated separately for the set of horizontal coordinates and the set of vertical coordinates. We label these two values Sigma-L and Sigma-S, reflecting the abscissa (L/(L+M))^{1/3} and ordinate (S/(L+M))^{1/3}. The percent change in the horizontal and vertical standard deviations caused by the filter are measures of the filter performance along those axes. The term “Sigma” is used here to refer to this percent change in the standard deviations along a specified axis caused by the filter. Because Sigma is a percent change, it can take on any value, positive or negative, where a positive value indicates that the average saturation of the color set is increased along the specified axis (expansion) and a negative value indicates the average saturation is decreased (contraction).

### Sigma(θ)

Sigma may also be calculated along other axes than the horizontal and vertical. This is done by first calculating the chromaticity coordinates both with and without the filter, then rotating the axes by an angle θ relative to the horizontal by multiplying each pair of chromaticity coordinates by the rotation matrix. Then, the standard deviation of the set of new horizontal coordinates is calculated. Repeated for values of θ∈[0°, 180°) yields the function Sigma(θ). The value of Sigma(θ) represents the performance of the filter (expansion/contraction) in a polar CES. Since Sigma(θ) measures the expansion/contraction in both the positive and negative directions along the given axis, it repeats after 180° and is symmetrical about the origin. Also note that the Cartesian values of the horizontal (Sigma-L) and vertical Sigma (Sigma-S) are equal to Sigma (0°) and Sigma (90°), respectively.

Each value of Sigma(θ) has a magnitude, r, which is the performance measure as a function of angle. The radius of the curve at a given angle is equal to 1+Sigma(θ)/100. A radius greater than 1 indicates a positive sigma value at that angle (expansion along that axis), a radius less than 1 indicates a negative sigma value (contraction), and a radius equal to 1 indicates no change. Therefore, the unit circle represents the case of no filter. The filter curve may be plotted against the unit circle to visualize the effect of the filter. Filter curves tend to be generally elliptical, with the major axis aligned along the direction with the greatest sigma, and the minor axis aligned along the direction of least (or most negative) sigma.

Filters designed to enhance color contrast and color saturation for some colors and not others are a well-known art. This invention designs filters from a plurality of narrow-band absorbers and broad band absorbers (e.g., polarizer film). The filter designs are then analyzed in a number of color spaces, primarily a modified MacLeod-Boynton Cone Excitation Space (CES) and a CIE color space, either 2-deg 1931 or 10-deg 1965. The method of design is referred to as Sigma. Sigma looks at a set of reflectance surfaces (the reflectance set) and evaluates performance of a filter design for Color Vision Normal (NCV) people, with the said designed filter placed in the light path from a standard illuminant, e.g., CIE D-65 Standard daylight. Available sets of reflectance surfaces can be the 100 reflectance surfaces from TM-30. [IES 2020] The TM-30 has the appeal of being widely available for download and being embedded in a widely available and free analysis tool IES TM-30-18 Basic Calculation Tool v2.01. [IES 2020] The primary method we use to analyze a filter design is to look at the standard deviation of the reflectance set. As with CVD, an exemplary filter design for NCV will leave Sigma-S relatively unchanged and increase Sigma-L significantly. It has also been found that there is an optimal range of angles, Sigma(θ)∈{20-45°}, that correspond to ideal color enhancement for greens and reds. Therefore, one function of the design tool is to increase r (r_{MAX}) for Sigma(θ)∈{20-45°}.

A superlative filter design that improves color vision for the NCV might improve color contrast perception for reddish and greenish colors in the reference set and leave the bluish and yellowish colors in the reference set unchanged. For the purpose of using Sigma, the reference set is displayed in a Cone Excitation Space (CES), specifically a modified MacLeod-Boynton CES, with abscissa and ordinate representing red-green and blue-yellow cardinal color axes, resp., and represented by L and S. Each reflectance surface can be defined as a point in the CES by taking the product of its spectra, a reference light source and the set of linear energy cone sensitivities, resulting in three products, L, M & S. These three values are used to construct the distribution of {L,S} values for the reference set, with the abscissa as L/(L+M) and the ordinate as S/(L+M). This is further modified by taking the cube root: L=[L/(L+M)]^{1/3} and S=[S/(L+M)]^{1/3}. This last step makes a more perceptually uniformly-scaled color space. One benefit of the CES is that it represents the second, post-receptoral stage of color vision processing where cortical mechanisms evaluate input from the LGN—more closely a perception than a signal. For Normal Color Vision (NCV) the set of photopigment sensitivity functions {L,M,S} is used. A good source {L,M,S)} is Colour & Vision Research Laboratory at cvrl.org.

For NCV a filter design that leads to more separation between M-cone and L-cone through wavelength-selective narrow-band filtering, will translate into an increased Sigma-L in CES. Some predominantly M-stimulating or L-stimulating colors that might not be visibly detectable due to small subtense caused by physical size or distance or embedded in chromatic or luminance noise or masked by broadband noise (fog or haze) may become easier to perceive. To be effective the increase in color saturation must be properly oriented in the CES. The lime-magenta and orange-cyan directions represented in CES are associated with higher-order visual processes beginning in the primary visual cortex, V1. Optimizing color contrast and perception along these general color directions should lead to improved performance on tests designed to measure color contrast, color naming and color scaling.

Other methods of filter evaluation exist, and some have similarities to this invention. The two most relevant are ANSI/IES TM-30 [IES 2020] and a method proposed by Moreland [Moreland et al., 2010]. ANSI/IES TM-30 (TM-30) is a method published by the Illuminating Engineering Society and used by the American National Standard Institute to evaluate illuminant color rendition. This method can be repurposed to evaluate filter designs by multiplying an illuminant spectrum by the filter spectrum and using the result as the test illuminant in the TM-30 method.

The TM-30 method is like Sigma in that they both model the effect on a set of reflectance spectra caused by a test spectrum compared to a reference. TM-30 calculates the isoluminant chromaticity coordinates (in the CIE CAM02-UCS [CIE, 2004]) for a set of 100 reflectance spectra under a test illuminant and a comparable reference illuminant: the CIE D-series illuminant of the same color temperature as the test illuminant. The colors are grouped into one of 16 bins according to their hue angle under the reference illuminant. The chromaticity coordinates of each color in a bin are averaged for both the reference and test illuminants. The change in this average for each bin is used to quantify the effect the test illuminant has on colors in that bin, and various metrics are calculated based on these changes to convey information about the color rendition of the test illuminant.

One way TM-30 displays this information is a curve called the “Color Vector Graphic.” This is a two-dimensional curve defined by 16 points (one for each hue bin) where each point is shifted away from the unit circle by the relative change to the bin average coordinates. It is like the Sigma filter curve in that the no-change condition is the unit circle, and filters tend to create elliptical shapes. In fact, the Color Vector Graphic was the inspiration for the Sigma filter curve because it is an intuitive and visual way to demonstrate the effect of a filter (or illuminant) on different colors.

However, there are some key differences between Sigma and TM-30. One difference is that Sigma compares a filtered illuminant to the same illuminant unfiltered, whereas TM-30 (adapted for evaluating filters) compares a filtered illuminant to a different illuminant of the same color temperature. This can in some cases result in the reference illuminant used by TM-30 being significantly different than the one used in Sigma.

Another difference between TM-30 and Sigma is that TM-30 evaluates different bins separately. Sigma, on the other hand, evaluates how the entire set changes. This means that if TM-30 shows increased saturation in bin 1, for example, then this is only saying that the colors in bin 1 have an increased chroma and does not say anything about any of the other colors. By contrast, if Sigma(θ) shows an increase at the same angle, then this is saying that every color in the set, on average, has increased saturation along that axis.

The method of Moreland [Moreland et. al., 2010] referenced herein as the Moreland-Dain Method (MDM) is more like the Cartesian embodiment of Sigma. MDM is used to evaluate filters offered for sale to assist CVD. As such MDM uses LL′S. M′MS and LMS cone spectra to evaluate filters for types of CVD and represents the performance in a modified MacLeod-Boynton CES. The change in standard deviation of a large set of reflectance surfaces is the primary measure. Filters that show little increase to the standard deviation of the set are considered poor performance. MDM does not use a transform matrix to evaluate filter designs in a polar CES, thus it provides no information about performance for the individual color axis L and S or their reorientation to max and min axis values of a rotated ellipse.

### Designing Contrast Enhancing Filters for NCV

### Designing for CVD

Sigma can be used to design filters for both NCV and for CVD. This design tool has allowed the present inventors to design high performance Color Contrast Enhancing (CCE) filters for the anomalous trichromacy form of CVD. Further, {L,S} can be calculated for NCV and CVD without or with filters. Comparison can then be made relative to NCV providing a performance figure of merit. The analysis of filter performance is as follows. The standard deviation of the reference set is calculated for NCV and six cases of CVD, representing mild, moderate and severe extent of deutan and protan CVD. Because CVD leads to a collapse of the CES along the abscissa (red-green), but not along the ordinate (blue-yellow), the standard deviation of L is reduced in magnitude, and the standard deviation of S is relatively unchanged (Table I). The greater the extent of CVD the more pronounced the collapse in the red-green direction, and therefore a smaller standard deviation of L. Inserting a filter into the calculation allows evaluation of its performance, which, as mentioned, can be made relative to the standard deviation of the set for NCV, and given as a percentage. It might be convenient to present the performance improvement as a ratio relative to NCV with no filter, or as the ellipticity relative to a value of unity.

### Designing for NCV

Designs for NCV have some significant differences. The first significant difference is the preferred orientation in CES is shifted away from the cardinal axes. For NCV the design goal is to maximize Sigma-L and minimize Sigma-S along axes diagonal between the cardinal directions L-M and S in CES. These axes correspond to lines bisecting the angles 45°-225° and 135°-315° (−45°). The response to color is tuned to these non-cardinal color directions, aligning with lime-magenta and orange-cyan, resp. Work by Kaneko et al. [Kaneko et al., 2020] using Sweep VEP has clearly demonstrated this directional tuning, with lobes of greater signal potential corresponding to hue tuning at approx. 30° and 60°. To best analyze filter designs for NCV Sigma is calculated as the vector sum of the scalar L and S by converting the Cartesian components to polar. Along the cardinal direction θ=0° Sigma(θ)=L and along the cardinal direction θ=90° Sigma(90)=S. The magnitude is the vector sum r.

Sigma changes with the angle θ (relative to the white point in CES). To evaluate the vector product of L and S we can convert the cartesian set {L, S} to polar (r,θ) using the rotation matrix.

To be clear, the analysis is performed at many angles and the results combined. The best approach is to apply the rotation matrix at 1-degree steps from 0°-180°. The goal is to enhance color contrast along the lime-magenta color direction and to leave color contrast relatively unchanged along the orange-cyan color direction. The preservation of a colors' blue-yellowness or orange-cyan relationship might have implications for NCV. For NCV information about the illuminant is analyzed by the colors of objects in a scene, especially colored objects along the blue-yellow color axis, giving a rationale for keeping Sigma(θ) minimum between the angle 60°-150° and 240°-330°. Uneven alteration of the scene objects' blue-yellowness will distort the knowledge about the illuminant. This might lead to confusion around what is a shadow versus a topological feature, and relative spatial position of these objects. [See e.g. Winkler et. al., 2015]

The second significant difference between designing filters for CVD and NCV is optimizing Sigma-L and Sigma-S for NCV and not for deutan and protan CVD. Extensive parametric analysis has shown the inventors how to manipulate the design spectra to maintain color neutrality, maintain color temperature, and with the correct range of luminous transmission while having Sigma-L large, Sigma-S small, and with the angle of rotation of Sigma(θ) optimized.

Sigma can be embedded into a filter design program to allow measure and visualization of performance as the filter is being designed. The design can be made as a summation of narrow-band and broad-band dyes, uv-absorbers, polarizers, anti-reflective coatings, flash-mirror coatings, and interference coatings. In its simplest embodiment the filter design is constructed from a sum of i-dyes' spectral extinction coefficients, which are concentration weighted (ci) and defined for a given filter thickness (x). This is shown below.

$${OD}_{λ , tot} = {\sum }_{i}^{n} {Log}_{10} ( {e}^{- {ϵ}_{i} {c}_{i} x} )$$

$${τ}_{λ , tot} = 1 {0}^{- {OD}_{λ , tot}}$$

where each “i” dye, has an extinction coefficient, ϵᵢ, and a concentration, cᵢ, for a given filter thickness x. The analysis can be made over the wavelength range 400-700 nm, or 380-730 nm or 380-780 nm, typically made at 1 nm step sizes. The optical density at each wavelength, OD_{λ,tot}, can be represented as transmittance at each wavelength, τ_{λ,tot}. Graphical presentation can represent the filter design as (λ, OD or) (λ, τ) over the wavelength range 400-700 nm.

To represent the effect of a filter for NCV we primarily use a color space based on the LMS cone sensitivity functions, instead of the more common CIE XYZ color matching functions. The MacLeod-Boynton CES is a representation of LMS excitation for NCV. The abscissa represents cone excitation for the [L−M] chromatic channels as L/(L+M). Along the ordinate cone excitation represents the [S−(L+M)] as S/(L+M). The numerator is the luminance. Similar analysis can be made in a DKL CES. Normalization is used to give a reference point for white, which can be the equal energy white, E, daylight D-65, or some other. We modify this CES by taking the cube root of the axes to make the space more perceptually scale-uniform. The reflectance set {R} can also be centered on the mean of the set, {R}ₘₑₐₙ.

To utilize this CES we select a set of reflective surfaces that are representative of the real world, both natural and man-made. One color set, herein referred to as Pantone set, consists of 246 reflectance spectra; chlorophyll, 18 from the Xrite Color Checker, 220 from the Pantone® Extended Gamut swatch book, and 7 more saturated colors from the Pantone® Neon swatch book. Another color set, called TM-30, is based on 100 reflective surfaces and supported by the IES. [IES 2020] A third set can be a formula-generated set of Gaussian reflectance surfaces, which has the advantage of being on equal hue angle step size and chroma step size. This set can be made very large (>900 reflective surfaces) or very small (16 reflective surfaces). A fourth set that can be used is 1,600 reflectance surfaces from Munsell Book of Color [Munsell, 1976] Regardless of the chosen set Sigma generates quite similar results for filter designs. We will use the TM-30 set in this analysis, because of its common use for other color vision analytical tools, such as IES TM-30-20, which will be discussed in some detail herein.

To improve color vision for NCV we can look at the effect of filter designs on the values of Sigma. The color experience of NCV can be altered by making certain colors appear more saturated and colors selected from opposing color categories appear more different (greater color contrast). A successful filter design will increase the value of the standard deviation of [L/(L+M)]^{1/3} as measured using the TM-30 reflectance set along specific angles in a polar CES, with a co-objective of minimizing change in the value of the standard deviation of [S/(L+M)]^{1/3}.

To reiterate, we characterize the directional expansion of data points in the CES by taking the standard deviation of the reflectance set for NCV without the filter and comparing it to the value for NCV with the filter. We denote the standard deviation of points in this CES Sigma as (σ), with GL representing the standard deviation of the reflectance set's L=[L/(L+M)]^{1/3} values, and as representing the standard deviation of the reflectance set's S=[S/(L+M)]^{1/3} values.

A relationship does exist between the Sigma(θ) results and the results from IES TM-30-18 Basic Calculation Tool v2.01 (IES TM-30). [IES 2020] Both models use the TM-30 reflectance set. The Sigma(θ) represents a map of values in a polar CES where the values are shifted due to the designed filter. In the IES TM-30 analysis a polar CMF space is used to map changes in chroma value due to the designed filter. The IES TM-30 organizes the data within 16 hue bins subtending 22.5° of angle, and the angle characterizing hue rotates opposite to the angle in the CES. This last point requires subtracting maximum and minimum Sigma(θ) values from 360° to correlate to the IES TM-30 angles. In addition, the magnitude of change in r does not correlate with the change in chroma in any obvious manner.

For the purpose of this invention we will exclusively use results generated with Sigma(θ) using the TM-30 reflectance set.

If we consider a percentage improvement in Sigma to be relative to unassisted NCV and use capital sigma to define the improvement, then we are designing to have σ_{L} be large and positive and σ_{S} to be close to zero. Specifically we want filter designs for NCV to have the following Sigma values: Category-3 sun lens: σ_{L}>30%; Category-2 sun lens: σ_{L}>15% while σ_{S} is bounded+/−10% for both category sun lenses. For NCV improvement is defined by the percent change in σ_{L} and σ_{S} relative to NCV without a filter.

The need to keep σ_{S} bounded close to zero is demonstrated experimentally and has a possible explanation in color theory. Filter design with σ_{S} outside the range −10 to +10 leads to color distortion. Filter designs can have both low σ_{S} and large delta-E, that is, have little blue-yellow or cyan-orange color distortion but be a highly tinted filter. This is clearly undesirable and demonstrates the need to control non CES values when designing an exemplary filter.

### Designing Sun Lenses for Normal Color Vision

To design highly effective color contrast enhancing (CCE) eyewear targeting NCV, the objective is to give maximum Sigma(θ) (>30), minimum Sigma(θ) (<6), with the angle of maximum Sigma(θ) being between 20° and 60°, and the angle of minimum Sigma(θ) more or less orthogonal to the angle of the maximum, low delta-E (<0.0100), VLT between 8-18% (Cat.3) or between 18-40% (Cat.2) and CCT between 5,000-9,000K.

Design is made in a modified MacLeod-Boynton CES. Cone signals are converted into differences as (L−M) and (S−(L+M)) representing the retinal level values of the chromatic channels. Cortical processing leads to a representation more aligned with the lime-magenta and orange-cyan directions in color space.

To better understand the relationship between the cone fundamentals (the spectral sensitivity curves of the L, M and S photopigments), as well as their CVD counterparts, L′ (deutan) and M′ (protan), an analysis is made herein based on color channel values. The red-green color channel carries the difference between L and M cone signals and the blue-yellow color channel carries the difference between S and the sum of L and M cone signals. This information can be used to determine the optimal wavelengths to absorb signal to enhance color vision.

One approach to design is fundamental. For three photopigments we need a minimum of two absorption bands to alter the quantal capture of the photopigments. The first step is to take the derivative of S−(L+M) with respect to wavelength and find the wavelength of zero slope. This is at 480 nm for NCV. Next, take the second derivative with respect to wavelength of the second channel value (L−M) and find the inflection point, which is the maximum value. This is 582/3 nm for NCV. A design based on this analysis would have two absorption bands. The absorption band at 480 nm is to maintain little change to the minimum Sigma(θ) value, and the absorption band at 582/3 nm is to maximize the difference in signal between L-cone and M-cone signals for a given stimulus.

Condition 1: S−(L+M) is a minimum: ∂[S−(L+M)]/∂λ=0
Condition 2: L-M is an inflection point:

$$Max \text{:} \frac{{\partial }^{2} [ L - M ]}{{\partial }^{2} λ}$$

### Exemplary Embodiments

Using the above defined conditions as a starting point filter designs were made using the method of summing extinction coefficients described above and analyzed using the Sigma method described above. In the exemplary embodiments filters were designed to have the maximum Sigma (θ) value high, the minimum Sigma(θ) value close to zero, the angle of rotation of the maximum Sigma (θ) well above the horizontal axis, the CCT being neither too low (brownish white) or too high (bluish white), with chromaticity close to the Blackbody locus thus maintaining a neutral tinted lens.

Designs were made from a weighted selection of twelve dyes. A select set of examples are given in Tables I-a and I-b.

TABLE I-a

| Design | NCV-107 | NCV-108 | NCV-109 | NCV-110 | NCV-111 | NCV-112 | NCV-113 |
|---|---|---|---|---|---|---|---|
| Sun Lens | 2 | 2 | 2 | 2 | 2 | 2 | 2 |
| Category | | | | | | | |
| VLT (%) | 27.2 | 27.8 | 25.8 | 25.4 | 25.9 | 25.6 | 26.1 |
| AE − Illuminant | 0.0123 | 0.0182 | 0.0348 | 0.0340 | 0.0201 | 0.0132 | 0.0129 |
| Avg. ΔE − Ill | 0.0129 | 0.0187 | 0.0351 | 0.0343 | 0.0205 | 0.0139 | 0.0134 |
| (D-series) | | | | | | | |
| CCT (K) | 5800 | 5610 | 5080 | 5100 | 5530 | 5800 | 5770 |
| Sigma-L | 14.7 | 15.5 | 16.4 | 16.5 | 15.8 | 17.3 | 15.2 |
| Sigma-S | 5.6 | 5.2 | 2.3 | 2.1 | 4.1 | 5.6 | 5.2 |
| Max Sigma(θ) | 35.7 | 34.9 | 35.6 | 36.2 | 36.4 | 37.4 | 36.3 |
| Min Sigma(θ) | −1.7 | −1.1 | −3.3 | −3.7 | −2.6 | −0.8 | −2.1 |
| Max Sigma angle | 36 | 35 | 34 | 34 | 35 | 35 | 35 |
| (deg) | | | | | | | |
| Min Sigma angle | 128 | 125 | 121 | 121 | 125 | 124 | 127 |
| (deg) | | | | | | | |

Table I-a shows the Sigma analysis for normal color vision. Designs for color contrast enhancing filters NCV-107 through NCV-113: Sigma values are calculated for the TM-30 reflectance set. Sun lens category is shown along with calculated values for VLT, ΔE-illuminant (D65), Avg. ΔE-illuminant (D series), and CCT. Sigma(θ) values are calculated using D-65 illuminant and the TM-30 reflectance set. Sigma(θ)=Sigma-L, Sigma(90)=Sigma-S, Max and Min Sigma(θ) and the angle of Max and Min Sigma(θ) are determined with 1-deg steps 0°-180°. VLT is the visible light transmission. ΔE is measured in a 1931 2-deg CIE chromaticity diagram and is the vector distance from the filter design's chromaticity to the illuminant's chromaticity. CCT is the correlated color temperature, measured in degrees Kelvin.

TABLE I-b

| Design | NCV-114 | NCV-115 | NCV-116 | NCV-117 | NCV-118 | NCV-119 |
|---|---|---|---|---|---|---|
| Sun Lens Category | 2 | 2 | 2 | 2 | 2 | 2 |
| VLT (%) | 25.4 | 24.4 | 24.3 | 24.0 | 23.5 | 22.3 |
| AE − Illuminant | 0.0122 | 0.0137 | 0.0048 | 0.0024 | 0.0023 | 0.0058 |
| Avg. ΔE − Ill | 0.0127 | 0.0142 | 0.0060 | 0.0041 | 0.0040 | 0.0057 |
| (D-series) | | | | | | |
| CCT (K) | 5800 | 5750 | 6120 | 6180 | 6280 | 6530 |
| Sigma-L | 15.0 | 15.3 | 16.0 | 15.5 | 13.9 | 14.9 |
| Sigma-S | 5.1 | 4.5 | 6.9 | 7.0 | 7.2 | 8.2 |
| Max Sigma(θ) | 36.5 | 36.7 | 37.5 | 37.5 | 36.9 | 37.9 |
| Min Sigma(θ) | −2.4 | −2.8 | −0.6 | −1.0 | −1.6 | −0.5 |
| Max Sigma angle | 36 | 35 | 36 | 36 | 37 | 37 |
| (deg) | | | | | | |
| Min Sigma angle | 127 | 126 | 128 | 129 | 131 | 131 |
| (deg) | | | | | | |

Table I-b shows the Sigma analysis for normal color vision. Designs for color contrast enhancing filters NCV-114 through NCV-119: Sigma values are calculated for the TM-30 reflectance set. Sun lens category is shown along with calculated values for VLT, ΔE-illuminant (D65), Avg. ΔE-illuminant (D series), and CCT. Sigma values are calculated using D-65 illuminant and the TM-30 reflectance set. Sigma(θ)=Sigma-L, Sigma(90)=Sigma-S, Max and Min Sigma and the angle of Max and Min Sigma are determined with 1-deg steps 0°-180°. VLT is the visible light transmission. ΔE is measured in a 1931 2-deg CIL chromaticity diagram and is the vector distance from the filter design's chromaticity to the illuminant's chromaticity. CCT is the correlated color temperature, measured in degrees Kelvin.

Tables I-a and I-b show designs with excellent performance values. In all examples Max Sigma(θ) has a magnitude greater than approx. 35, Min Sigma(θ) has a magnitude between 0 and −4, and Max angle is between 30° and 40°. The filters based on these designs having exemplary Sigma values with this tuned ellipse orientation should enhance colors approx. along the lime-magenta color axis while having little change to colors along the cyan-orange color axis.

All of the designs have VLT in the proper Cat. 2 sun lens range, have ΔE below 0.200 (with the exception of NCV-109 and NCV-110), and CCT 4,500-7,000K. Examples NCV-209 and NCV-110 are included to show examples with exemplary performance except with respect to ΔE-Illuminant (D65) and with respect to ΔE-Ill (D-series). These two examples will not maintain lens color neutrality during changes to the phase of daylight from warm (D50) to cool (D80).

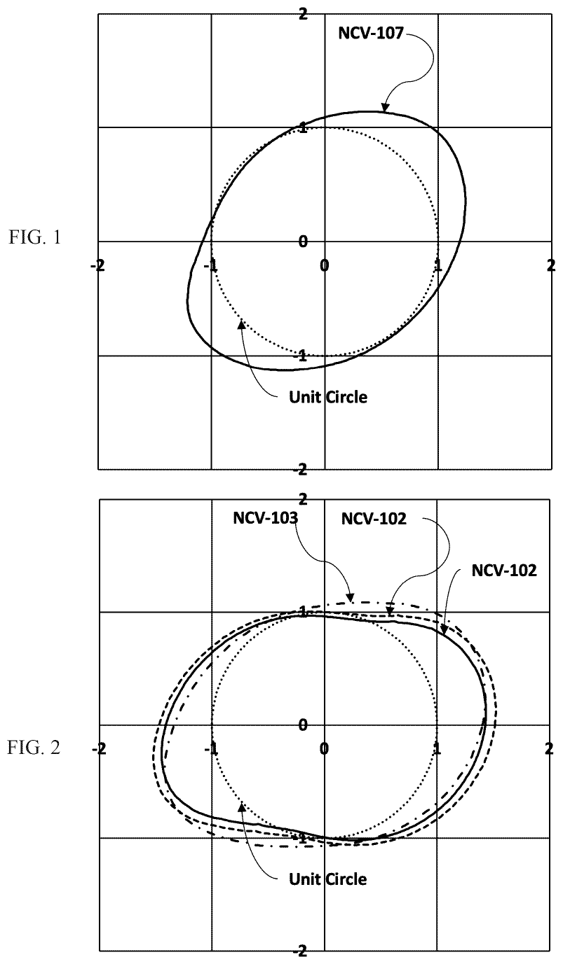

Selected Sigma(θ) plots for filter designs NCV-107 and NCV-108 in Table I-a are shown in FIG. 1. The “Sigma(θ) plots” are polar plots of r magnitude.

It is possible to make designs with very high Sigma-L values, but at the expense of other desirable properties. Table I-c explores this in a limited number of examples.

TABLE I-c

| Design | NCV-101 | NCV-102 | NCV-103 | NCV-104 | NCV-105 | NCV-121 |
|---|---|---|---|---|---|---|
| Sun Lens Category | 2 | 3 | 3 | 3 | 2 | 3 |
| VLT (%) | 39.7 | 31.3 | 29.7 | 28.7 | 32.2 | 16.9 |
| AE − Illuminant | 0.0327 | 0.0506 | 0.0205 | 0.0187 | 0.0251 | 0.0134 |
| Avg. ΔE − Ill | 0.0327 | 0.0502 | 0.0215 | 0.0199 | 0.0256 | 0.0141 |
| (D-series) | | | | | | |
| CCT (K) | 7880 | 9370 | 6590 | 6120 | 5370 | 5760 |
| Sigma-L | 42.5 | 50.0 | 37.9 | 37.4 | 29.8 | 26.9 |
| Sigma-S | −5.0 | −0.9 | 3.0 | 1.6 | −6.1 | 2.1 |
| Max Sigma(θ) | 46.2 | 54.8 | 48.8 | 49.2 | 38.8 | 46.1 |
| Min Sigma(θ) | −6.8 | −2.3 | 2.6 | 1.0 | −6.2 | −2.1 |
| Max Sigma angle (deg) | 14 | 15 | 24 | 24 | 22 | 30 |
| Min Sigma angle (deg) | 79 | 80 | 97 | 98 | 93 | 113 |

Table I-c shows the Sigma analysis for normal color vision. Designs for color contrast enhancing filters NCV-101 through NCV-105: Sigma(θ) values are calculated for the TM-30 reflectance set. Sun lens category is shown along with calculated values for VLT, ΔE-illuminant (D65), Avg. ΔE-illuminant (D series), and CCT. Sigma(θ) values are calculated using D-65 illuminant and the TM-30 reflectance set. Sigma(θ)=Sigma-L, Sigma(90)=Sigma-S, Max and Min Sigma(θ) and the angle of Max and Min Sigma(θ) are determined with 1-deg steps 0°-180°. VLT is the visible light transmission. ΔE is measured in a 1931 2-deg CIE chromaticity diagram and is the vector distance from the filter design's chromaticity to the illuminant's chromaticity. CCT is the correlated color temperature, measured in degrees Kelvin.

Table I-c gives examples of Max Sigma(θ) magnitude above 35, above 45, and in one case at 55, while keeping Min Sigma(θ) of low magnitude. NCV-101 has ΔE-illuminant and Avg. ΔE-Ill (D-series) too large, a CCT too large and Max Sigma angle too low. NCV-102 has ΔE-illuminant and Avg. ΔE-Ill (D-series) too large, a CCT too large and Max Sigma angle too low. NCV-103 has ΔE-illuminant and Avg. ΔE-Ill (D-series) marginally outside the acceptable range, with the remaining properties of high performance. NCV-104 is an exemplary high Sigma-L Cat. 2 sun lens filter design. NCV-105 has ΔE-illuminant and Avg. ΔE-Ill (D-series) too large, with the remaining properties of high performance. NCV-106 is an exemplary high Sigma-L Cat. 3 sun lens filter design.

The Sigma(θ) plots for filter designs NCV-101, NCV-102, and NCV-103 in Table I-c are shown in FIG. 2.

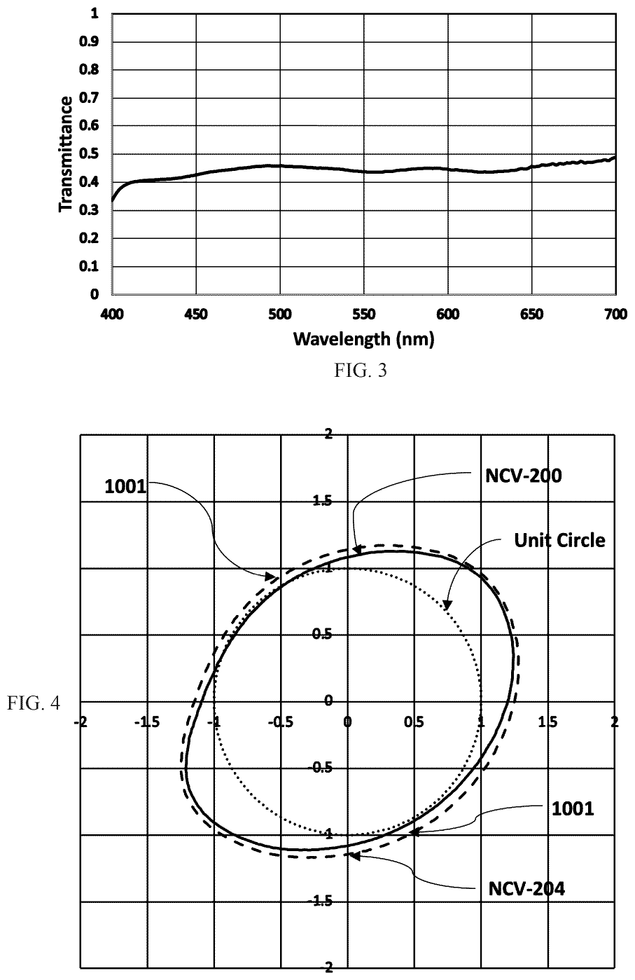

It is also possible to make Cat.3 polarized versions for NCV. Examples are given in Table I-d, and the polarizer used in this analysis is shown as a spectral plot in FIG. 3.

TABLE I-d

| | Design NCV∥P∥ series | | | | | | | |
|---|---|---|---|---|---|---|---|---|
| | P-107 | P-113 | P-200 | P-201 | P-202 | P-203 | P-204 | P-122 |
| Sun Lens | 3 | 3 | 3 | 3 | 3 | 3 | 3 | 3 |
| Category | | | | | | | | |
| VLT (%) | 15.4 | 14.9 | 15.1 | 14.8 | 14.6 | 14.0 | 14.1 | 10.3 |
| AE − Illuminant | 0.0193 | 0.0217 | 0.0117 | 0.0089 | 0.0149 | 0.0183 | 0.0262 | 0.0036 |
| Avg. ΔE − Ill | 0.0196 | 0.0220 | 0.0123 | 0.0098 | 0.0152 | 0.0182 | 0.0257 | 0.0054 |
| (D-series) | | | | | | | | |
| CCT (K) | 5550 | 5470 | 5830 | 6160 | 6570 | 6860 | 7380 | 6320 |
| Sigma-L | 13.3 | 14.4 | 14.9 | 16.4 | 18.0 | 19.5 | 20.0 | 25.9 |
| Sigma-S | 3.2 | 2.6 | 5.0 | 6.9 | 8.8 | 9.6 | 11.2 | 4.2 |
| Max Sigma(θ) | 32.4 | 33.2 | 33.4 | 34.2 | 34.8 | 36.5 | 36.6 | 43.0 |
| Min Sigma(θ) | −3.0 | −3.2 | −0.9 | 1.3 | 3.6 | 4.5 | 6.1 | 0.6 |
| Max Sigma | 35 | 34 | 35 | 35 | 35 | 34 | 35 | 30 |
| angle (deg) | | | | | | | | |
| Min Sigma | 125 | 123 | 125 | 125 | 125 | 124 | 125 | 113 |
| angle (deg) | | | | | | | | |

Table I-d shows sigma analysis for polarized filter designs for normal color vision. The polarized filter is HT-S50 (see FIG. 2) Sigma values are calculated for the TM-30 reflectance set. Sun lens category is shown along with calculated values for VLT, ΔE-illuminant (D65), Avg. ΔE-illuminant (D series), and CCT. Sigma values are calculated using D-65 illuminant and the TM-30 reflectance set. Sigma(θ)=Sigma-L, Sigma(90)=Sigma-S, Max and Min Sigma and the angle of Max and Min Sigma are determined with 1-deg steps 0°-180°. VLT is the visible light transmission. ΔE is measured in a 1931 2-deg CIE chromaticity diagram and is the vector distance from the filter design's chromaticity to the illuminant's chromaticity. CCT is the correlated color temperature, measured in degrees Kelvin.

Table I-d gives examples of polarized filter designs. NCV∥P∥-107 is an exemplary Cat.3 polarized sun lens with high Sigma Max and Max Sigma. NCV∥P∥-113 is a polarized Cat.3 sun lens with ΔE-illuminant and Avg. ΔE-Ill (D-series) too large, with the remaining properties of high performance. NCV∥P∥-200 is an exemplary Cat.3 polarized sun lens with high Sigma Max and Max Sigma. NCV∥P∥-201 is an exemplary Cat.3 polarized sun lens with high Sigma Max and Max Sigma. NCV∥P∥-202 is an exemplary Cat.3 polarized sun lens with high Sigma Max and Max Sigma. NCV∥P∥-203 is an exemplary Cat.3 polarized sun lens with high Sigma Max and Max Sigma. NCV∥P∥-204 is a polarized Cat.3 sun lens with ΔE-illuminant and Avg. ΔE-Ill (D-series) too large, with the remaining properties of high performance. NCV∥P∥-205 is an exemplary Cat.3 polarized sun lens with high Sigma Max and Max Sigma.

The Sigma(θ) plots for filter designs NCV-107 in Table I-d are shown in FIG. 1. The Sigma(θ) plots for filter designs P-200 (NCV-200) and P-204 (NCV-204) in Table I-d are shown in FIG. 4.

In the case of NCV the importance of maintaining a sense of an object's blue-yellowness might help maintain consistency of the illuminant. In our filter designs there are many examples of high σ_{L}, low σ_{S} and high ΔE, but no examples of high σ_{L}, high σ_{S} and low ΔE. If the filter has neutral color, then there is little blue-yellow distortion. This is a strong argument to maintain color neutrality for eyewear, esp. intended for low-vision users. Examples of this effect are illustrated in Table I-d and FIG. 4 for designs P-200 and P-204. In FIG. 4 feature ‘1005’ indicates where the Sigma Min is increased for P-204 (NCV-204) relative to P-200 (NCV-200) and the effect this has on ΔE—Illuminant shown in Table 1-d: the value has more than doubled leading to a less neutral colored filter and more distortion along the blue-yellow color direction.

### Calculating Sigma(θ) for the SuperX® Filter

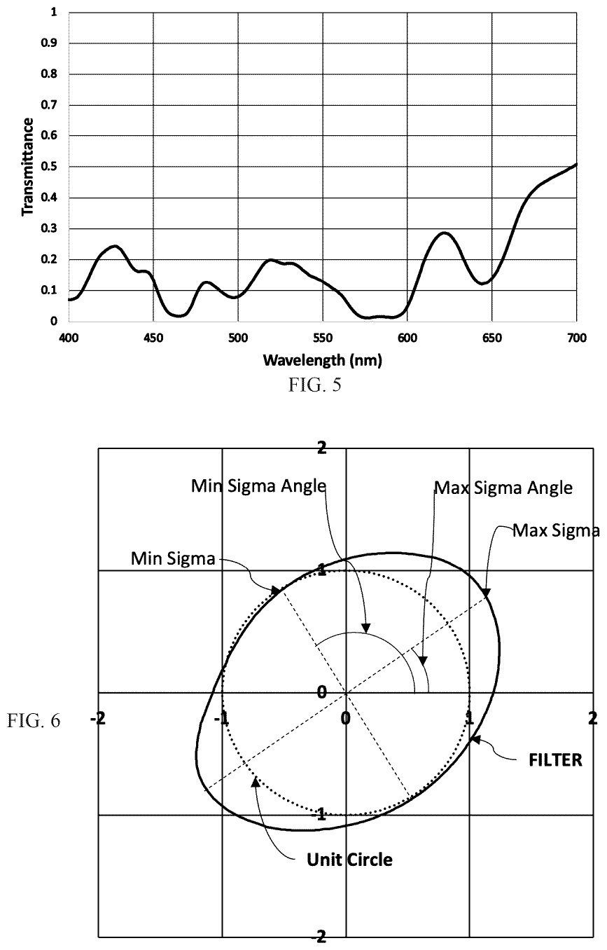

The following describes in detail the process for calculating Sigma(θ). The SuperX® filter is used for example calculations (FIG. 5). SuperX® is a sun lens filter, based on polycarbonate with a green antireflective front coating and a neutral antireflective back coating. Super-X® is a category 3 sun lens, is polarized and has excellent performance.

Let R̅ be a 100×301 matrix, where the rows contain the 100 reflectance spectra used by in the ANSI/IES TM-30-20 standard, in 1 nm step sizes over the range [400, 700]. [IES 2020] Let L̅, M̅, and S̅ be 301×1 matrices of the L, M, and S cone fundamentals, in 1 nm step sizes over the range [400, 700]. [Stockman et al., 1999][Stockman et al., 2000] Let Ī be a 301×1 by matrix of the CIE D65 illuminant, in 1 nm step sizes over the range [400, 700]. [IES 2020] Let F̅ be a 301×1 matrix of the transmission spectrum of the filter under consideration in 1 nm step sizes over the range [400, 700].

The LMS coordinates of each color in the color set both without and with the filter are calculated by the following:

$$\overline{L} = \overline{R} * ( 0.69284 * \overline{L} ⊙ \overline{I} ) \qquad Equation 1$$

$$\overline{M} = \overline{R} * ( 0.34968 * \overline{M} ⊙ \overline{I} )$$

$$\overline{S} = \overline{R} * ( 0.001 \; 28 * \overline{S} ⊙ \overline{I} )$$

$$\overline{{L}_{F}} = \overline{R} * ( 0.692 \; 84 * \overline{L} ⊙ \overline{I} ⊙ \overline{F} )$$

$$\overline{{M}_{F}} = \overline{R} * ( 0.34968 * \overline{M} ⊙ \overline{I} ⊙ \overline{F} )$$

$$\overline{{S}_{F}} = \overline{R} * ( 0.00128 * \overline{S} ⊙ \overline{I} ⊙ \overline{F} )$$

The symbol ⊙ denotes element-wise multiplication. The symbol * denotes matrix multiplication. The subscript _{F} indicates that the corresponding value is calculated with the filter. L̅, M̅, S̅, L̅_̅{̅F̅}̅, M̅_̅{̅F̅}̅, S̅_̅{̅F̅}̅ are all 100×1 matrices containing the L, M, or S coordinates for each of the 100 colors in the color set.

TABLE II

| λ[nm] | L̅ | | Ī (CIE D65) | | | 0.69284 * (L̅ ⊙ Ī) |
|---|---|---|---|---|---|---|
| 400 | 0.0024084 | * | 0.00572902 | * 0.69284 | = | 9.5596E−06 |
| 401 | 0.00279521 | * | 0.00580984 | * 0.69284 | = | 1.1252E−05 |
| 402 | 0.00322644 | * | 0.00587284 | * 0.69284 | = | 1.3128E−05 |
| 403 | 0.00370624 | * | 0.00592567 | * 0.69284 | = | 1.5216E−05 |
| 404 | 0.0042398 | * | 0.00597596 | * 0.69284 | = | 1.7554E−05 |
| 405 | 0.00483348 | * | 0.00603134 | * 0.69284 | = | 2.0198E−05 |
| . . . | . . . | . . . | . . . | . . . | . . . | . . . |
| 696 | 0.00788239 | * | 0.00490986 | * 0.69284 | = | 2.6814E−05 |
| 697 | 0.00733227 | * | 0.00492218 | * 0.69284 | = | 2.5005E−05 |
| 698 | 0.00681938 | * | 0.00493471 | * 0.69284 | = | 2.3315E−05 |
| 699 | 0.00634185 | * | 0.00494799 | * 0.69284 | = | 2.1741E−05 |
| 700 | 0.00589757 | * | 0.00496263 | * 0.69284 | = | 2.0278E−05 |

Table II shows example calculation of 0.69284*(L̅⊙Ī).

TABLE III

| | | | | | | | | 0.69284* |
|---|---|---|---|---|---|---|---|---|
| | | | Ī | | | | | (̅L̅ ⊙ |
| λ[nm] | L̅ | | (CIE D65) | | F̅ (SuperX) | | | Ī ⊙ F̅) |
| 400 | 0.0024084 | * | 0.00572902 | * | 0.7365 | * 0.69284 | = | 9.5596E−06 |
| 401 | 0.00279521 | * | 0.00580984 | * | 0.0732 | * 0.69284 | = | 1.1252E−05 |
| 402 | 0.00322644 | * | 0.00587284 | * | 0.07305 | * 0.69284 | = | 1.3128E−05 |
| 403 | 0.00370624 | * | 0.00592567 | * | 0.0741 | * 0.69284 | = | 1.5216E−05 |
| 404 | 0.0042398 | * | 0.00597596 | * | 0.0755 | * 0.69284 | = | 1.7554E−05 |
| 405 | 0.00483348 | * | 0.00603134 | * | 0.07755 | * 0.69284 | = | 2.0198E−05 |
| . . . | . . . | . . . | . . . | . . . | . . . | . . . | . . . | . . . |
| 695 | 0.00847173 | * | 0.00489714 | * | 0.47655 | * 0.69284 | = | 2.8744E−05 |
| 696 | 0.00788239 | * | 0.00490986 | * | 0.48115 | * 0.69284 | = | 2.6814E−05 |
| 697 | 0.00733227 | * | 0.00492218 | * | 0.4835 | * 0.69284 | = | 2.5005E−05 |
| 698 | 0.00681938 | * | 0.00493471 | * | 0.48595 | * 0.69284 | = | 2.3315E−05 |
| 699 | 0.00634185 | * | 0.00494799 | * | 0.49115 | * 0.69284 | = | 2.1741E−05 |
| 700 | 0.00589757 | * | 0.00496263 | * | 0.4939 | * 0.69284 | = | 2.0278E−05 |

Table III shows example calculation of 0.69284*(L̅⊙Ī⊙F̅) for the SuperX® filter.

TABLE IV

| λ[nm] | R1 | R2 | R3 | R4 | | R97 | R98 | R99 | R100 |
|---|---|---|---|---|---|---|---|---|---|
| 400 | 1.0000 | 0.6359 | 0.2615 | 0.0117 | . . . | 0.4339 | 0.1766 | 0.3104 | 0.2092 |
| 401 | 1.0000 | 0.6364 | 0.2618 | 0.0102 | . . . | 0.4389 | 0.1788 | 0.3116 | 0.2106 |
| 402 | 1.0000 | 0.6372 | 0.2623 | 0.0087 | . . . | 0.4438 | 0.1820 | 0.3133 | 0.2127 |
| 403 | 1.0000 | 0.6381 | 0.2629 | 0.0074 | . . . | 0.4486 | 0.1860 | 0.3155 | 0.2152 |
| 404 | 1.0000 | 0.6391 | 0.2635 | 0.0061 | . . . | 0.4536 | 0.1902 | 0.3179 | 0.2178 |
| 405 | 1.0000 | 0.6402 | 0.2641 | 0.0051 | . . . | 0.4586 | 0.1945 | 0.3203 | 0.2204 |
| . . . | . . . | . . . | . . . | . . . | . . . | . . . | . . . | . . . | . . . |
| 695 | 1.0000 | 0.8909 | 0.7668 | 0.2021 | . . . | 0.8886 | 0.2802 | 0.8149 | 0.6329 |
| 696 | 1.0000 | 0.8913 | 0.7687 | 0.2026 | . . . | 0.8890 | 0.2784 | 0.8183 | 0.6332 |
| 697 | 1.0000 | 0.8918 | 0.7706 | 0.2028 | . . . | 0.8891 | 0.2766 | 0.8215 | 0.6334 |
| 698 | 1.0000 | 0.8921 | 0.7723 | 0.2028 | . . . | 0.8892 | 0.2750 | 0.8244 | 0.6336 |
| 699 | 1.0000 | 0.8924 | 0.7737 | 0.2031 | . . . | 0.8894 | 0.2737 | 0.8266 | 0.6337 |
| 700 | 1.0000 | 0.8926 | 0.7746 | 0.2039 | . . . | 0.8899 | 0.2728 | 0.8281 | 0.6338 |

Table IV shows fragment of R̅, the reflectance spectra from the TM-30 color set.

TABLE V

| | L̅ | M̅ | S̅ | L̅_̅{̅F̅}̅ | M̅_̅{̅F̅}̅ | S̅_̅{̅F̅}̅ |
|---|---|---|---|---|---|---|
| R1 | 0.54229185 | 0.23448484 | 0.00054887 | 0.06301379 | 0.02672614 | 6.8496E−05 |
| R2 | 0.33558238 | 0.13139963 | 0.00033631 | 0.03934425 | 0.01443112 | 4.2852E−05 |
| R3 | 0.13944289 | 0.04245609 | 0.0001248 | 0.01795407 | 0.00449869 | 1.6515E−05 |
| R4 | 0.03136417 | 0.01152489 | 2.7561E−05 | 0.00415753 | 0.00131864 | 3.1416E−06 |
| . . . | . . . | . . . | . . . | . . . | . . . | . . . |
| R97 | 0.26469257 | 0.10516332 | 0.0003012 | 0.03241025 | 0.01185364 | 3.7659E−05 |
| R98 | 0.09374099 | 0.03213312 | 0.00011366 | 0.00970963 | 0.00289695 | 1.4824E−05 |
| R99 | 0.15489868 | 0.04980789 | 0.00016794 | 0.01890582 | 0.00514807 | 2.2206E−05 |
| R100 | 0.09518994 | 0.02831894 | 0.00010297 | 0.01389143 | 0.00333406 | 1.3672E−05 |

Table V shows some of the resulting values of L̅, M̅, S̅, L̅_̅{̅F̅}̅, M̅_̅{̅F̅}̅, S̅_̅{̅F̅}̅ for the SuperX® filter.

Let [symbol] , [symbol] , [symbol] , and [symbol] be 100×1 matrices of the coordinates in cone excitation space of each color in the color set, without and with the filter. The ith elements in [symbol] , [symbol] , [symbol] , and [symbol] are calculated by:

$${L}_{i} = \sqrt[3]{\frac{{L}_{i}}{{L}_{i} + {M}_{i}}} \qquad Equation 2$$

$${S}_{i} = \sqrt[3]{\frac{{S}_{i}}{{L}_{i} + {M}_{i}}}$$

$${L}_{Fi} = \sqrt[3]{\frac{{L}_{Fi}}{{L}_{Fi} + {M}_{Fi}}}$$

$${S}_{Fi} = \sqrt[3]{\frac{{S}_{Fi}}{{L}_{Fi} + {M}_{Fi}}}$$

where Lᵢ, Mᵢ, Sᵢ, L_{Fi}, M_{Ri}, S_{Fi} are the ith elements of L̅, M̅, S̅, L̅_̅{̅F̅}̅, M̅_̅{̅F̅}̅, S̅_̅{̅F̅}̅ respectively.

TABLE VI

| | [symbol] | [symbol] | [symbol] | [symbol] |
|---|---|---|---|---|
| R1 | 0.88711304 | 0.08906836 | 0.88882576 | 0.09138901 |
| R2 | 0.89570775 | 0.08963503 | 0.90108541 | 0.09271091 |
| R3 | 0.91521269 | 0.08819784 | 0.9281775 | 0.09026863 |
| R4 | 0.90093978 | 0.08629446 | 0.91226196 | 0.08309155 |
| . . . | . . . | . . . | . . . | . . . |
| R97 | 0.89447815 | 0.09338474 | 0.90131705 | 0.09475578 |
| R98 | 0.90642327 | 0.09665621 | 0.91664628 | 0.10554905 |
| R99 | 0.91125231 | 0.09361351 | 0.92286195 | 0.09737004 |
| R100 | 0.91684859 | 0.09411654 | 0.93080443 | 0.0925872 |

Table VI shows some of the resulting values of [symbol] , [symbol] , [symbol] , and [symbol] for the SuperX® filter.

Let [symbol] and [symbol] be the sets of cone excitation space coordinates along the axis at an angle θ to the horizontal. This is equivalent to a rotation of the coordinate axes by an angle of −θ. They are calculated by:

$$\overline{L ( θ )} = \overline{L} * cos θ + \overline{S} * sin θ \qquad Equation 3$$

$$\overline{{L}_{F} ( θ )} = \overline{{L}_{F}} * cos θ + \overline{{S}_{F}} * sin θ$$

Let σ(θ) and σ_{F}(θ) be the standard deviations of [symbol] and [symbol] , calculated by:

$$σ ( θ ) = \frac{{\sum }_{i} {( {L ( θ )}_{i} - μ ( θ ) )}^{2}}{N} \qquad Equation 4$$

$${σ}_{F} ( θ ) = \frac{{\sum }_{i} {( {{L}_{F} ( θ )}_{i} - {μ}_{F} ( θ ) )}^{2}}{N}$$

Where μ(θ) and μ_{F}(θ) are the means of [symbol] and [symbol] , respectively, and N is the vector length, 100.
Let Sigma(θ) be the percent change in σ_{F}(θ) relative to σ(θ):

$$Sigma ( θ ) = 100 * ( \frac{{σ}_{F} ( θ )}{σ ( θ )} - 1 ) \qquad Equation 5$$

These calculations are repeated for angles between [0°, 180°). Because there is 180° rotational symmetry, the values for angles [180°, 360°) are the same, and do not need to be calculated. Sigma(θ) can be represented in a polar plot as deviations to the unit circle. In such a plot, the unit circle represents the color set without a filter, i.e. no change. The effect of the filter is represented by a polar curve:

$${r}_{F} ( θ ) = \frac{Sigma ( θ )}{100} + 1 = \frac{{σ}_{F} ( θ )}{σ ( θ )} \qquad Equation 6$$

This function is defined for angles between [0°, 360°) to create a closed curve, with the values for angles [180°, 360°) being equal to those for [0°, 180°). A plot of the function is helpful for visualizing the effect of the filter, and in particular the maximum and minimum values and the angles they occur at.

The following tables show example calculations for this process for the SuperX® filter.

TABLE VII-a

| | [symbol] | | [symbol] | | | [symbol] |
|---|---|---|---|---|---|---|
| R1 | 0.88711304 | * cos(45)+ | 0.08906836 | * sin(45) | = | 0.69026449 |
| R2 | 0.89570775 | * cos(45)+ | 0.08963503 | * sin(45) | = | 0.69674257 |
| R3 | 0.91521269 | * cos(45)+ | 0.08819784 | * sin(45) | = | 0.70951839 |
| R4 | 0.90093978 | * cos(45)+ | 0.08629446 | * sin(45) | = | 0.69808002 |
| . . . | . . . | . . . | . . . | . . . | . . . | . . . |
| R97 | 0.89447815 | * cos(45)+ | 0.09338474 | * sin(45) | = | 0.69852455 |
| R98 | 0.90642327 | * cos(45)+ | 0.09665621 | * sin(45) | = | 0.7092843 |
| R99 | 0.91125231 | * cos(45)+ | 0.09361351 | * sin(45) | = | 0.71054743 |
| R100 | 0.91684859 | * cos(45)+ | 0.09411654 | * sin(45) | = | 0.7148603 |

Table VII-a contains sample calculations of [symbol] for the SuperX® filter for θ=45°.

TABLE VII-b

| | L̅_̅{̅F̅}̅ | | S̅_̅{̅F̅}̅ | | | L̅_̅{̅F̅}̅(̅4̅5̅°̅)̅ |
|---|---|---|---|---|---|---|
| R1 | 0.88882576 | * cos(45)+ | 0.09138901 | * sin(45) | = | 0.69311651 |
| R2 | 0.90108541 | * cos(45)+ | 0.09271091 | * sin(45) | = | 0.70272012 |
| R3 | 0.9281775 | * cos(45)+ | 0.09026863 | * sin(45) | = | 0.72015016 |
| R4 | 0.91226196 | * cos(45)+ | 0.08309155 | * sin(45) | = | 0.70382121 |
| . . . | . . . | . . . | . . . | . . . | . . . | . . . |
| R97 | 0.90131705 | * cos(45)+ | 0.09475578 | * sin(45) | = | 0.70432985 |
| R98 | 0.91664628 | * cos(45)+ | 0.10554905 | * sin(45) | = | 0.72280125 |
| R99 | 0.92286195 | * cos(45)+ | 0.09737004 | * sin(45) | = | 0.72141296 |
| R100 | 0.93080443 | * cos(45)+ | 0.0925872 | * sin(45) | = | 0.72364716 |

Table VII-b contains sample calculations of [symbol] for the SuperX® filter for θ=45°.

TABLE VIII

| θ (deg) | | σ_{F}(θ) | | σ(θ) | | Sigma(θ) |
|---|---|---|---|---|---|---|
| 0 | 100 * ( | 0.01946296 | / | 0.01504809 | −1)= | 29.3384347 |
| 1 | 100 * ( | 0.01937405 | / | 0.01491044 | −1)= | 29.9361466 |
| 2 | 100 * ( | 0.01928391 | / | 0.01477351 | −1)= | 30.5302926 |
| . . . | . . . | . . . | . . . | . . . | . . . | . . . |
| 24 | 100 * ( | 0.01720502 | / | 0.01236232 | −1)= | 39.173126 |
| . . . | . . . | . . . | . . . | . . . | . . . | . . . |
| 45 | 100 * ( | 0.01585043 | / | 0.01233512 | −1)= | 28.4984209 |
| . . . | . . . | . . . | . . . | . . . | . . . | . . . |
| 90 | 100 * ( | 0.01790386 | / | 0.01776948 | −1)= | 0.75624572 |
| . . . | . . . | . . . | . . . | . . . | . . . | . . . |
| 98 | 100 * ( | 0.01867648 | / | 0.01862284 | −1)= | 0.28802066 |
| . . . | . . . | . . . | . . . | . . . | . . . | . . . |
| 178 | 100 * ( | 0.01963678 | / | 0.01532485 | −1)= | 28.1368407 |
| 179 | 100 * ( | 0.01955057 | / | 0.01518629 | −1)= | 28.7383116 |

Table VIII shows some of the resulting values of Sigma(θ) for the SuperX® filter for different values of θ, σ(θ) and σ_{F}(θ) are the standard deviations of [symbol] and [symbol] calculated by equation 5.

TABLE IX

| θ (deg) | σ_{F}(θ) | | σ(θ) | | r_{F}(θ) |
|---|---|---|---|---|---|
| 0 | 0.01946296 | / | 0.01504809 | = | 1.29338435 |
| 1 | 0.01937405 | / | 0.01491044 | = | 1.29936147 |
| 2 | 0.01928391 | / | 0.01477351 | = | 1.30530293 |
| . . . | . . . | . . . | . . . | . . . | . . . |
| 24 | 0.01720502 | / | 0.01236232 | = | 1.39173126 |
| . . . | . . . | . . . | . . . | . . . | . . . |
| 45 | 0.01585043 | / | 0.01233512 | = | 1.28498421 |
| . . . | . . . | . . . | . . . | . . . | . . . |
| 90 | 0.01790386 | / | 0.01776948 | = | 1.00756246 |
| . . . | . . . | . . . | . . . | . . . | . . . |
| 98 | 0.01867648 | / | 0.01862284 | = | 1.00288021 |
| . . . | . . . | . . . | . . . | . . . | . . . |
| 178 | 0.01963678 | / | 0.01532485 | = | 1.28136841 |
| 179 | 0.01955057 | / | 0.01518629 | = | 1.28738312 |

Table IX shows some of the resulting values of r_{F}(θ) for the SuperX® filter for different values of θ. This data is plotted in FIG. 6.

TABLE X

| | |
|---|---|
| Sigma(0) | 29.3384347 |
| Sigma(90) | 0.75624572 |
| Max Sigma(θ) | 39.173126 |
| θmax (deg) | 24 |
| Min Sigma(θ) | 0.28802066 |
| θmin (deg) | 98 |

Table X shows the relevant Sigma(θ) values for the SuperX® filter. Sigma(θ) is the value of Sigma(θ) at the angle θ=0°. Sigma(90) is the value of Sigma(θ) at the angle θ=90°. Max Sigma(θ) is the maximum value of Sigma(θ) and θmax is the angle at which the maximum value occurs, in degrees. Min Sigma(θ) is the minimum value of Sigma(θ) and θmin is the angle at which the minimum value occurs, in degrees.

Lens brightness and color are also important qualities of a good filter design. These may be quantified using the CIE 1931 color space, using the 2-deg standard observer. The values xyY should be calculated for the filter using the CIE D65 Illuminant. These may then be expressed as the quantities VLT and ΔE_{I}. VLT is equal to the CIE Y value expressed as a percent. ΔE_{I} is the Euclidean distance in xy-chromaticity space from the filter color to the illuminant color:

$$Δ {E}_{I} = \sqrt{{( x - {x}_{I} )}^{2} + {( y - {y}_{I} )}^{2}}$$

### Equation 7

Where x and y are the xy chromaticity coordinates of the filter with the CIE D65 illuminant, and x_{I} and y_{I} are the chromaticity coordinates of the CIE D65 illuminant with no filter.

TABLE XI

| Embodiment | SuperX ® |
|---|---|
| Sun Lens Category | 3 |
| Polarized? | YES |
| VLT (%) | 11.6 |
| ΔE_{I} (D65) | 0.0138 |
| Avg. ΔE - Ill (D-series) | 0.0142 |
| CCT (K) | 6670 |

Table XI contains other relevant values for the SuperX® filter. Polarized Super-X filter properties at approx. 2.0 mm lens thickness. Sun Lens category-3 is 8-18%, Visible Light Transmission (VLT) is within category-3, ΔE_{I}(D65) is the Cartesian distance in the CIE 1931 2-deg color space from the illuminant (D65) and the filter plus illuminant, Avg. ΔE-Ill (D-series) is the average Cartesian distance in the CIE 1931 2-deg color space for the set of D-illuminants; D50, D55, D60, D65, D70, D75, D80, and CCT is the Correlated Color Temperature in degrees Kelvin.

Super-X filter is a polarized sun lens. Sun lens category is shown along with calculated values for VLT, ΔE-illuminant (D65), Avg. ΔE-illuminant (D series), and CCT. Sigma(θ) values are calculated using D-65 illuminant and the TM-30 reflectance set. Sigma(0)=Sigma-L, Sigma(90)=Sigma-S, Max and Min Sigma(θ) and the angle of Max and Min Sigma(θ) are determined with 1-deg steps 0°-180°. VLT is the visible light transmission. ΔE is measured in a 1931 2-deg CIE chromaticity diagram and is the vector distance from the filter design's chromaticity to the illuminant's chromaticity. CCT is the correlated color temperature, measured in degrees Kelvin.

What is claimed is:

1. An optical filter having a transmission spectrum that gives a maximum Sigma(θ) at θmax and a minimum Sigma(θ) at θmin, wherein the maximum Sigma(θ) at θmax is greater than 35, θmax is between 20 to 60 degrees, and the minimum Sigma(θ) at θmin is between −10 and 10.

2. The optical filter of claim 1, wherein the filter has a chromaticity, measured under D-65 illuminant, less than 0.0200 distance from the chromaticity of the illuminant in the CIE 1931 2-deg color space, and with the correlated color temperature being greater than 4,500K and less than 7,000K, and the visible light transmission being greater than 9% and less than 18%.

3. The optical filter of claim 2, wherein the visible light transmission is greater than 11% and less than 16%.

4. The optical filter of claim 1, wherein the filter has a chromaticity, measured under D-65 illuminant, less than 0.0200 distance from the chromaticity of the illuminant in the CIE 1931 2-deg color space, and with the correlated color temperature being greater than 4,500K and less than 7,000K, and the visible light transmission being greater than 18% and less than 40%.

5. The optical filter of claim 4, wherein the visible light transmission is greater than 22% and less than 29%.

6. The optical filter of claim 4, wherein the visible light transmission is greater than 24% and less than 27%.

7. The optical filter of claim 1, wherein the filter has a chromaticity, measured under D-65 illuminant, less than 0.0200 distance from the chromaticity of the illuminant in the CIE 1931 2-deg color space, where the filter reduces brightness equating to approximately 8-18% VLT, has a correlated color temperature between 4,500-7,000 K, has a maximum saturation greater than 1.45 (45%) and oriented between 20-40 degrees, the minimum saturation being between −1.05 and 1.05 (−5 and +5%) and oriented approximately orthogonal to the angle of maximum saturations.

8. The optical filter of claim 1, wherein the filter has a chromaticity, measured under D-65 illuminant, less than 0.0200 distance from the chromaticity of the illuminant in the CIE 1931 2-deg color space, where the filter reduces brightness equating to approximately 18-40% VLT, has a correlated color temperature between 4,500-7,000 K, has a maximum saturation greater than 1.45 (45%) and oriented between 20-40 degrees, the minimum saturation being between −1.05 and 1.05 (−5 and +5%) and oriented approximately orthogonal to the angle of maximum saturations.

9. The optical filter of claim 1, wherein the filter incorporates a polarizer element.

10. The optical filter of claim 1, wherein the minimum Sigma(θ) at θmin is between −10 and 10 and θmin is between 80 to 120 degrees.

11. An optical filter having a transmission spectrum that gives a maximum Sigma(θ) at θmax and a minimum Sigma(θ) at θmin, wherein the maximum Sigma(θ) at θmax is greater than 25, θmax is between 20 to 60 degrees, and the minimum Sigma(θ) at θmin is between −6 and 6.

12. The optical filter of claim 11, wherein the filter has a chromaticity, measured under D-65 illuminant, less than 0.0200 distance from the chromaticity of the illuminant in the CIE 1931 2-deg color space, and with the correlated color temperature being greater than 4,500K and less than 7,000K, and the visible light transmission being greater than 18% and less than 40%.

13. The optical filter of claim 12, wherein the visible light transmission is greater than 22% and less than 29%.

14. The optical filter of claim 12, wherein the visible light transmission is greater than 24% and less than 27%.

15. The optical filter of claim 11, wherein the filter has a chromaticity, measured under D-65 illuminant, less than 0.0200 distance from the chromaticity of the illuminant in the CIE 1931 2-deg color space, where the filter reduces brightness equating to approximately 18-40% VLT, has a correlated color temperature between 4,500-7,000 K, has a maximum saturation greater than 1.45 (45%) and oriented between 20-40 degrees, the minimum saturation being between −1.05 and 1.05 (−5 and +5%) and oriented approximately orthogonal to the angle of maximum saturations.
